(19) United States
(12) Patent Application Publication
(10) Pub. No.: US 2007/0211911 A1
(43) Pub. Date: Sep. 13, 2007

(54) Microphone With Inlet Structure

(76) Inventor: Gunner Sie, Virum (DK)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 10/593,879

(22) PCT Filed: Mar. 15, 2005
(86) PCT No.: PCT/EP05/51170

§ 371 Date: Sep. 22, 2006

(30) Foreign Application Priority Data
Mar. 25, 2004 (DK) PA 2004 00483

(51) Int. Cl. H04R 1/00

(52) U.S. Cl. 381/122

(57) ABSTRACT

A microphone inlet structure has a sound duct between an opening in a first face of a microphone casing and a gasket area, whereby the gasket area is shaped to extend around the opening in the microphone casing and to follow the outline of the first face at least in the area near the opening.

### AREA OF THE INVENTION

The invention relates to a microphone with an inlet structure for use in an ITE hearing aid or similar audio device.

### BACKGROUND OF THE INVENTION

In audio devices which are to be worn in or partially in the ear canal it is often wished by the user, that the device remains as inconspicuous as possible, which means that the device should be places as deep as possible in the ear canal. At the same time directionality is also in high demand, and this requires either large directional microphones or at least two omnidirectional microphones which have to be built into the device. When doing this it is important to keep overall measures as small as possible and at the same time obtain the longest distance possible between microphone inlets in the front plate (hereinafter named faceplate). It is an object of the invention to provide a microphone with an inlet structure which allows the microphone to be built into the faceplate, such that the overall measures remains small while at the same time the distance between the microphone inlets can be made as big as possible. This is to be done without compromising instrument size, sound channel length and without compromising ease of manufacturing.

### SUMMARY OF THE INVENTION

According to the invention a microphone with an inlet structure is provided which comprises a sound duct between an opening in a first face of a microphone casing and a gasket area, whereby the gasket area is shaped to extend around the opening in the microphone casing and to follow the outline of the first face at least in the area near the opening.

When the microphone with the inlet structure is mounted in the faceplate the microphone sound duct forms an air tight connection with a sound passage leading from the back side to the front side of the faceplate. With the invention it is ensured that the opening to the sound passage in the faceplate above the microphone can be provided close to the outline of the microphone. And further it is ensured that a pair of microphone according to the invention can be used to obtain the longest possible distance between the sound inlets in the faceplate and at the same time obtaining the smallest possible size of the hearing aid. The provision of the gasket area at the outline of the microphone face also helps to give a sound path from the surface of the faceplate to the microphone which is as short as possible. This is important as it will aid to avoid resonance in the system.

In an embodiment of the invention the sound duct is shaped with a recess above the opening in the first face. The recess helps to guide sound to the opening in the face of the microphone, even if the inner wall of the sound duct at places pass over this opening.

Advantageous embodiments are mentioned in the claims.

### BRIEF DESCRIPTION OF THE DRAWINGS

FIG. 1 shows a perspective view of a microphone with an inlet structure according to the invention with a cut out region of the inlet structure,

FIG. 2 is a side view of a pair of microphones according to the invention mounted in an end to end relation in a faceplate,

FIG. 3 is a side view of a pair of microphones according to the invention mounted in a side to side relation in a faceplate,

FIG. 4 shows 3 different examples of the possible shape of the sound duct in the faceplate with a microphone according to the invention,

FIG. 5 shows two examples of prior art microphones with circular sound inlet,

FIG. 6 shows two examples of the microphone with an inlet structure according to the invention seen from above,

FIG. 7 is an enlarged view of an example of a microphone with inlet structure mounted in the faceplate,

FIG. 8 is an enlarged view of an example of a microphone with inlet structure mounted in the faceplate

FIG. 9 shows a further embodiment of the invention in a sectional side view,

FIG. 10 is a sectional side view of yet another embodiment of the invention.

### DESCRIPTION OF A PREFERRED EMBODIMENT

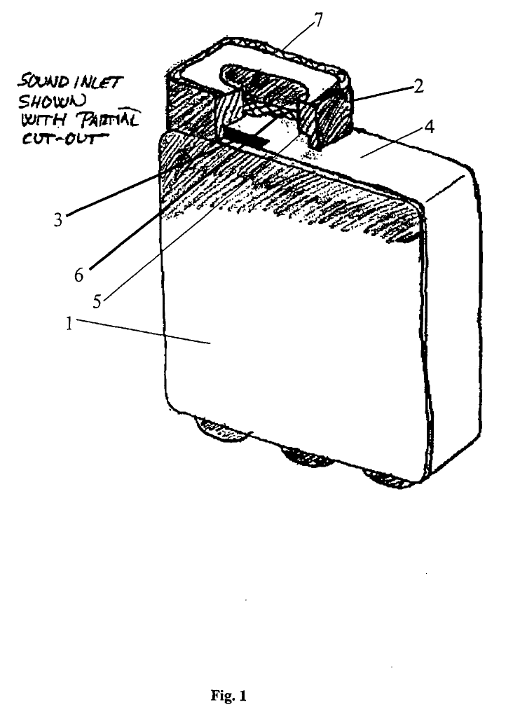

The microphone 1 according to the invention shown in FIG. 1 has an opening 3 in a first face 4 of the microphone 1, and above the opening 3 a sound duct 2 is positioned. The opening 3 is placed near the intersection of a long side and a short side of the face 4. As seen the face 4 is quadratic in shape, but round or square faces could also be used according to the shape of the microphone. The sound duct 2 has a gasket area 7 which is supposed to provide a gasket means against the underside of the faceplate, when the microphone 1 is mounted in the faceplate 30. Further the sound duct has a recess 5 above the opening 3 wherein an acoustic filter 6 is mounted. The filter may be provided in many different ways but mounting in the recess is easy and simple. Further the recess 5 has the function of guiding the sound to the opening 3.

As seen in FIG. 1 the gasket area 7 is caused to follow the outline of the face 4 at least in the region around the opening 3. With relation to FIGS. 2, 3, 5 and 6 it is explained below what is achieved hereby.

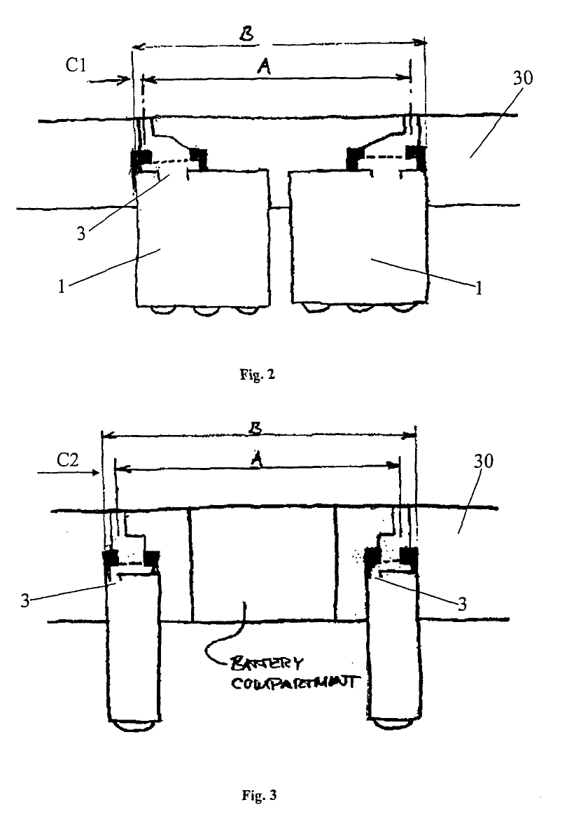

FIGS. 2 and 3 shows the microphones 1 according to the invention mounted in two different ways in a face plate 30. In FIG. 2 the microphones 1 are placed in end to end relationship alongside a battery drawer (not shown), and in FIG. 3 the microphones 1 are mounted side by side with the battery drawer between the two microphones 1. In both possibilities it is wished, that the distance A between the acoustic centres of the two sound inlet openings in the face plate 30 should be as long as possible, such that the best possible directionality can be obtained. At the same time it is wished that the distance B should be as little as possible, because this is the limiting factor for the overall size of the finished hearing aid. Thus the measures C1 and C2 should be minimized.

In FIG. 5 two examples of prior art hearing aids are shown with round sound ducts 22. The sound duct 22 has a packing or gasket means associated therewith (not shown). The projection of the faceplate opening is shown at 23. In example a, the microphones are to be placed in end to end relation and the opening in the faceplate 23 is placed as close to the short side 25 of the face 24 as possible. In example a, the measure D1 corresponds to the measure C1 in FIG. 2 and in example b the measure D2 corresponds to the measure C2 in FIG. 3.

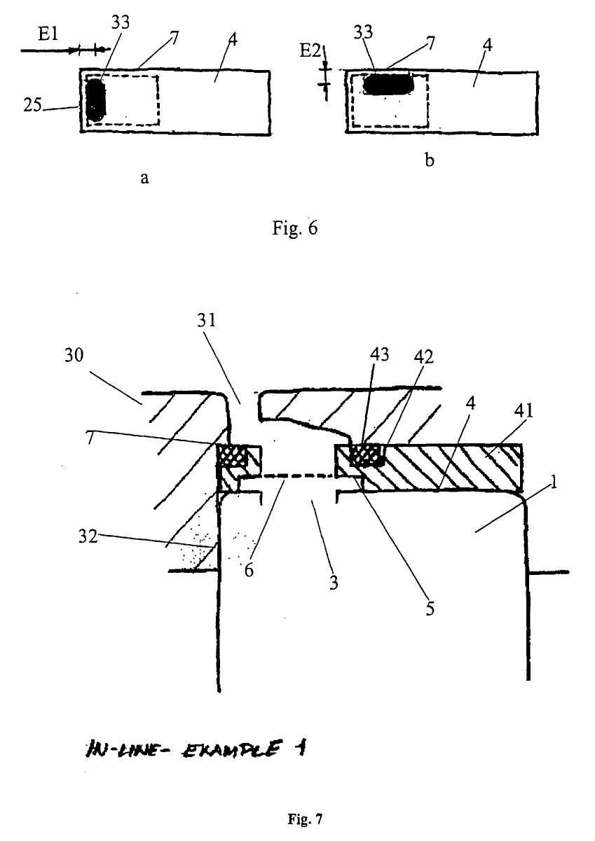

The microphone according to the invention is shown in FIG. 6, example a and b, seen from above. Example a corresponds to one of the microphones in FIG. 2 and here the gasket area 7 is shown to extend along the outline of the face 4, and the outline of the sound inlet duct in the faceplate is shown at 33. The distance E1 is smaller than the corresponding distance D1 in the prior art microphone structure of FIG. 5 example a. Similarly the distance E2 in FIG. 6, example b is smaller than the corresponding distance D2 in a prior art microphone as displayed in FIG. 5, example b. The oval shaped openings in the faceplate 33 are used here because it is wished that the acoustic centre of the opening should be as close as possible to the outline of the microphone and at the same time demands for a minimum opening area has to be met.

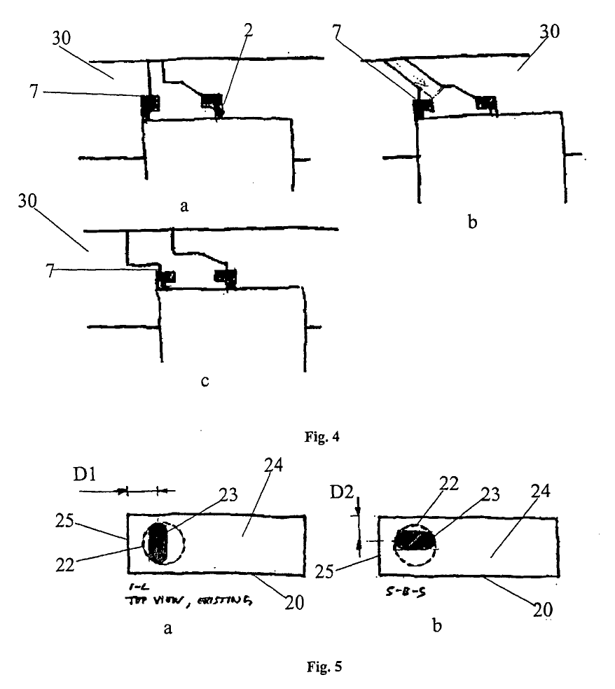

In FIG. 4 three examples a, b and c of the shape of the sound duct in the faceplate 30 are given. In example b the sound duct is inclined in respect to the surface of the faceplate 30 and this gives an added distance between two microphone ports, and this added distance is added to the effect of the gasket area being placed along the outline of the face of the microphone having the opening 3. In example c the same effect is obtained with the use of a stepped sound duct. For the example b and c it should be noted, that the demands on the tooling for producing the faceplates is higher than for the faceplate of example a. Thus it is preferred to have straight sound ducts as shown in example a.

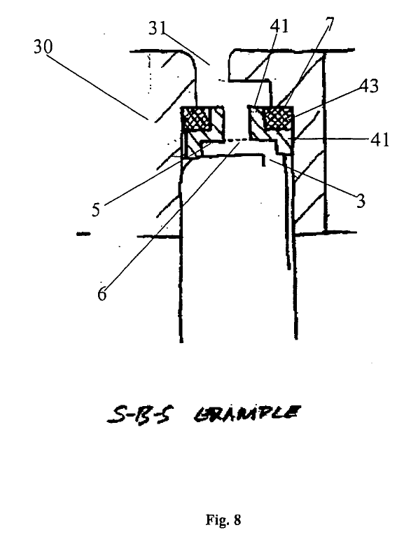

In FIGS. 7 and 8 enlarged views of a microphone 1 corresponding to the one displayed in FIGS. 2 and 3 respectively are shown. Here the sound duct comprises a plate part 41, which is shaped to follow the contours of the face 4 of the microphone 1. At the top of the plate part 41 a recess 42 is arranged and in the recess a gasket material 43 is arranged. The gasket material 43 is flexible and will provide a tight seal against the underside of the faceplate 30 around the opening of the sound duct 31 in the faceplate. At the underside of the plate part 41 a recess 5 is provided and in the recess 5 the filter 6 is arranged. The microphone is mounted in a rectangular recess 32 in the underside of the faceplate 30. The recess 32 has the same outline as the face 4 of the microphone 1 with the opening 3. The plate part 41 may be cemented against the microphone face 4. The recess 32 should preferably not be any bigger than the outline of the face 4 of the microphone in order to keep the overall size of the hearing aid as small as possible. Thus the outline of the plate part 41 and the gasket 43 should not extend beyond the borderlines of the face 4 of the microphone 1.

In FIG. 8 it can be seen that the fact that the outline of the gasket area 7 of the gasket 43 follows the shape of the face 4 of the microphone 1, allows the sound duct 31 in the faceplate 30 to have an acoustic centre close to the outline of the microphone 1. Also it should be noted that the construction of the sound duct 2 allows the same microphone to be used in end to end relation as seen in FIGS. 7 and 2 and in side by side relation as seen in FIGS. 8 and 3.

In the embodiment according to FIGS. 7 and 8 the gasket material 43 is cemented against the plate 41, but other ways of providing the gasket between the sound duct of the microphone and the sound canal in the face plate are available. Integrally moulding of the gasket on the plate 41 or in the faceplate 30 is one possibility. Further gaskets based on adhesive tapes are available and techniques for handling such tapes have been developed. Also use of flexible cements in the gasket area is a feasible solution, whereby the two component sound duct can be reduced to a one component part.

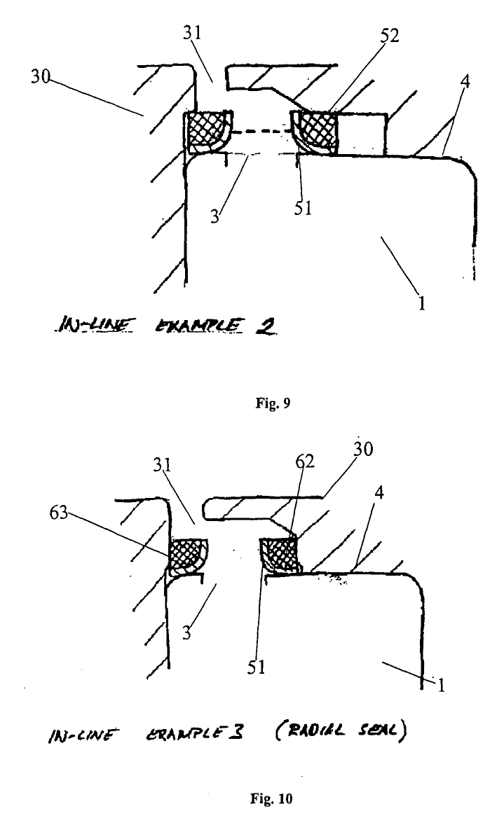

In FIG. 9 a further embodiment of the invention is shown. Here the plate part is omitted and a metal collar 51 is provided above the opening 3 in the microphone. Around the metal collar a gasket 52 is arranged which is to provide a sound tight seal against the underside of the sound duct 31 in the faceplate 30. Here the collar 51 provides the sound duct above the microphone opening 3, and the gasket 52 follows the outline of the microphone face 4 at least in the area around the opening 3.

In FIG. 10 a further embodiment of the invention is displayed. Here a gasket 62 is provided around a metal collar 51, whereby the gasket 62 has a radial sealing area 63, which is to form a sound tight sealing against the inside of the sound duct 31 in the faceplate 30. Also here the outline of the sealing area 63 of the gasket 62 is to follow the rim of face 4 of the microphone 1 at least in the area of the opening 3.

1. Microphone with inlet structure comprising a sound duct between an opening in a first face of a microphone casing and a gasket area, whereby the gasket area is shaped to extend around the opening in the microphone casing and to follow the outline of the first face at least in the area near the opening.

2. Microphone with inlet structure as claimed in claim 1, wherein the sound duct is shaped with a recess above the opening in the first face.

3. Microphone with inlet structure as claimed in claim 1 and where an acoustic filter is arranged in the sound duct.

4. Microphone with inlet structure as claimed in claim 1, wherein the sound duct is provided by a first part and a second part, where the first part is adhered to the first face of the microphone and the second part is positioned adjacently to the first part and comprises a resilient rim along the gasket area.

5. Microphone with inlet structure as claimed in claim 1, wherein sealing between the faceplate and the sound duct is provided by cement or adhesive foil.

6. Microphone with inlet structure as claimed in claim 3, whereby the first part is shaped to extend along the face with the opening and cover said face entirely, and where the second part is shaped to encompass a minor part of said face.

7. Microphone with inlet structure as claimed in claim 1, whereby the gasket area is shaped to provide packing in an axial direction in relation to the sound duct.

8. Microphone with inlet structure as claimed in claim 1, whereby the gasket area is shaped to provide packing in a radial direction in relation to the sound duct.

9. Microphone with inlet structure as claimed in claim 1, whereby the gasket area is shaped to provide packing in an axial direction in relation to the sound duct.
